(19) United States
(12) Patent Application Publication
(10) Pub. No.: US 2014/0220370 A1
(43) Pub. Date: Aug. 7, 2014

(54) Tube for the End Consumer with Minimum Interior and Exterior Oxidation, with Grains that may be Selectable in Size and Order; and Production Process of Tubes

(71) Applicant: MADECO MILLS S.A., San Miguel, Santiago (CL)

(72) Inventors: Eduardo Andrés Morel Rodríguez, Santiago (CL); Eduardo Alfonso Valdebenito López, Santiago (CL); Marco Antonio Carrasco Gálvez, Santiago (CL)

(73) Assignee: Madeco Mills S.A., San Miguel, Santiago (CL)

(21) Appl. No.: 13/976,363

(22) PCT Filed: Feb. 4, 2013
(86) PCT No.: PCT/CL2013/000007

§ 371 Date: Jun. 26, 2013

(51) Int. Cl. B22D 11/00; B29C 71/00; B29C 55/22

(52) U.S. Cl. CPC B22D 11/006; B29C 55/22; B29C 71/009
USPC 428/544; 428/34.1; 428/36.9; 428/34.4; 164/465; 264/175; 264/85

(57) ABSTRACT

In the tube manufacturing industry, five general methodologies for manufacturing tubes are known at this time. The first is under an extrusion of molten metal by means of a press. The second is by means of a rotary lamination system known as “Piercing” or “Mannesmann”. The third is the welded pre-tube that is obtained from a laminated strip. The fourth, known as the “Cast & Roll” system, whereby a pre-tube, obtained directly from the melting, is laminated by a triple roller system. Finally, the innovative manner whereby a continuous vertical casting manufactures pre-tubes continuously, directly from the melt.

The four first systems are widely used in the industry to manufacture what is known as a “pre-tube” that usually has a diameter of 60 mm or higher, which we shall name “old pre-tube”. Different processes are applied to that old pre-tube to bring it to smaller diameters and thicknesses finally required by the market.

The invention set forth in this specification considers implementing a production process through a productive line of a continuous vertical casting machine that produces a direct pre-tube from the melt, which we shall call “new pre-tube”. Later, as a second step, that new pre-tube passes through two simultaneous, synchronized wiredrawing machines and finally, through an induction annealing furnace. Thus, a product can be obtained for commercialization that complies with international standards, which can be reduced to a smaller size by wiredrawing it using the customary processes of the industry.

This innovative process represents the continuation and solving of technical problems derived from the processing of the new pre-tube to form a standardized commercial tube in accordance with patent application 1935-2011 and PCT/CL2012/00013.

### TRADITIONAL PROCEDURE

As was indicated previously, the traditional process generally commences with the melting of material with which cylinders, commonly known as “billets” (technical term), are cast in a range of 9.8 cm (3.5 inches) and 25.4 cm (10 inches) o more. Then these billets are heated at high temperatures to later be extruded in a high pressure press, or perforated and lengthened by means of mechanical systems whose result is what is known in the industry as “pre-tube” which, as we pointed out, will be referred to in this specification as “old pre-tube”. This old pre-tube has a length that is predetermined by the size and weight of the billet. In the industry, the weight of the billet currently oscillates between 75 and 400 kilos, which restricts the size of the old pre-tube because it must be limited to the capacity of the extrusion press or the perforators.

Once the old pre-tube is formed, it passes through a series of wiredrawing processes that consist, basically, of stretching and reducing the thickness of its walls by using traction to pass it through:
i. A tungsten carbide die;
ii. With a “plug” or “chuck” or “mandrel”.

Both are shown in FIGS. 1 and 2.

In other words, the old system consists of passing a tube through a die or hollow plate whose hole has walls of tungsten carbide of a diameter smaller than the mentioned tube. The tube is threaded through said hole (after reducing its diameter at one end) and a plug or metallic cylinder with a diameter somewhat larger than the hole in the sheet is placed within the pre-tube. Thus, when traction is applied to the tube, the mentioned plug is pushed by the tube, locks and permits the reduction of the thickness of the wall while passing through the die, as shown in FIGS. 1 and 2. The execution of this process is necessary because the initial old pre-tube has a diameter larger than 60 mm, which requires that it be reduced until the commercial standardized measurements are reached. It is important to point out that not more than 30% of the tube's original dimension is reduced in each wiredrawing process. In view of the latter, the tube must necessarily be passed repeatedly through this wiredrawing process to reach the commercially required diameters. For example, the mass-produced end product, generally of a nominal % inch according to ASTM standard B-88, whose real diameter is ⅞ of an inch (22.22 mm) must pass through at least 10 processes to reach those diameters (FIG. 4), which raises the cost of the process and, therefore, of the tube, especially due to the consumption of the following associated supplies:
High energy expenditure,
Unnecessary cost increase of materials,
Labor intensive in excess, and
Generating of cuttings of the old pre-tubes (or losses of material) that is produced for 3 reasons, mainly:
   First, in order to thread the tube in the die (to make it pass through its hole) and thus be able to apply traction with regard to same, the size needs to be reduced (taper one end), deforming the first 30 or 40 cm of each tube each time it passes, which material is then lost.
   The second source of loss is material breakage. As the diameter of the tube gets smaller, the tractions become more intense and the material accumulates stress deformation with each passing. If there is an imperfection in the tube, the tube breaks and produces a loss of material.
   Finally, the third source of loss is the final dimensioning of the product that will depend directly on the length of the old pre-tube or the weight of the billet and the size required by the end customer.

### INNOVATIVE PROCESS OF THIS INVENTION

The production process of this invention consists of unifying in a three-stage production line to obtain a standardized tube that is equivalent to one eighth of the process of the traditional line. These can be seen in FIG. 5.

The stages of this online production process will be described below:

### CONTINUOUS VERTICAL CASTING

The continuous vertical casting process is a process that was created in the nineteen seventies for the exclusive manufacture of oxygen free high conductivity (OFHC) wire rod.

During the month of May 2008, a failed casting occurred in one of these machines at Madeco that produced a continuous hollow wire rod. This continuous hollow wire rod, after multiple breakthroughs and tests, finally became the origin of patent application 1935-2011 and application PCT/CL2012/00013.

From that moment and to this date, different ways have been tried to obtain tubes from this type of casting machine. It has been possible to standardize the casting process in a pre-tube of 38×2.5 mm.

With regard to the operation of the casting machine, following is a description of the melting process and initiation of the casting.

An automatic loading machine feeds copper cathodes into the smelting furnace, where the melted metal is maintained at a temperature of 1160±5° C. covered with a layer of graphite in flakes to partially avoid its oxidation.

Prior to starting the casting process, a special cooler is set up with a graphite matrix, a kaowool cup, a graphite cup and a mortar, all shown in FIG. 7.

The casting process is started with the insertion of a steel tube (“fishing rod”) with a piece of perforated steel on the tip (FIG. 8). When this assembly is inserted in the liquid metal, the liquid metal enters the graphite matrix and solidifies on the perforated point, it is left to settle for a short time and then the fishing rod is pulled upward with the help of the traction machine and the pinch rolls (FIG. 9 and FIG. 10), when the metal pre-tube has passed over the traction table the fishing rod is removed and its point cut (FIG. 11). At that moment, that pre-tube stands up by itself and is taken to the receivers where they are accumulated. Henceforth the mentioned pre-tubes made using this process will be called “new pre-tubes”.

These new pre-tubes have two special characteristics that distinguish them from the old pre-tubes and that interfere with their reduction to marketable sizes. These are:
a. Their structural micro sequencing, of disorderly (depending on their cooling) and large size grains that produce:
   i. The fragility of that pre-tube in the wiredrawing process; and,
   ii. Easy appearance of micro fissures in the wiredrawing process; and
b. Their resulting rapid oxidation that produces the breakage of the pre-tube in the wiredrawing process due to the emanation of the particles of free oxides.

With the invention described in this process we have successfully resolved all the above-mentioned problems.

The materiality of the tube comprises a metal and/or a non metal, a metal alloy, metal compound, metal-ceramic alloy, ceramic or a polymer, preferably copper.

One object of this patent is the sequence of additional steps required to ensure that the new pre-tube (just taken from the continuous vertical casting machine) can end up being a marketable product.

Another object of this patent is to obtain a tube in which the type of grain required for its application can be selected, which includes a tube with a minimum or no degree of oxidation.

Some characteristics of the tube, preferably of copper, obtained with the process that will be described below, are: that it has grains whose formation is homogeneous, preferably equiaxial, with an average grain size in the range of 0.025 mm to 0.050 mm, preferably of 0.040 mm.

Moreover, chemically the copper tube has a sulfur concentration range of 2 ppm-12 ppm, preferably 6.6 ppm and an oxygen concentration range of 5 ppm-12 ppm, preferably 10.5 ppm.

With regard to the process proposed in this invention, the sequence of steps required will be indicated.

### WIREDRAWING PROCESS

As was commented with regard to the old system, the wiredrawing process consists, basically, of stretching and reducing the thickness of the walls of a tube by using traction to pass the tube through a tungsten carbide die with a plug or chuck or mandrel inside it until the desired result is achieved. There are different ways in which to execute the wiredrawing process, as shown in FIGS. 2 and 3.

The type of wiredrawing for the new pre-tubes originating from the continuous vertical casting is the floating plug type indicated in FIG. 2 mentioned previously.

The new pre-tube is received from the continuous casting with measurements of 38.00×2.50 mm +/−5%. It is then taken to the wiredrawing sector where a double wiredrawing process is carried out thanks to the joining and synchronization of two wiredrawing machines that work in tandem.

The material is prepared before starting the wiredrawing process. The new pre-tube is brought close to the jig borer where it is lubricated on the inside, a tungsten carbide plug is inserted (FIG. 1) and subsequently a point is made at the beginning of the rolled up tube, which is then inserted in a winder to start up the wiredrawing line at a constant speed using paraffin as an exterior lubricating/refrigerating agent. The new pre-tube passes through the first wiredrawing machine (FIG. 12), then through a stress regulator (FIG. 13), then the mentioned new pre-tube passes through the second wiredrawing machine (FIG. 14) that executes the second section reduction using the mentioned lubricant/coolant to finally accumulate the material in a receiver that is inserted in baskets (FIG. 15) in which the material is transferred to the following stage (annealing oven and cooling chamber).

### ANNEALING OVEN AND COOLING CHAMBER

The mechanical properties of the tube are recovered in this process (a re-crystallization of the tube takes place).

Without this step it would be impossible to control the pre-tube's fragility in the wiredrawing process as the structural arrangement that it has enables the appearance of micro-fissures, as was said, disorderly and large size grains, and their attendant rapid oxidation that produces their breakage in the wiredrawing process due to the emanation of free oxide particles. The wiredrawing process cannot be carried out satisfactorily without solving those problems.

The material received from the wiredrawers is inserted manually into the inlet guides of the furnace (FIG. 16).

To start the process, the inside of the new pre-tube is purged with a noble gas, preferably nitrogen. It then enters a chamber where a solvent, such as turpentine, is applied to the exterior of the tube to remove the lubricant and other elements that affect the process such as dust, shavings or stains, among others. The tube then enters a furnace where induction coils are used to heat the metal. This furnace works at a maximum speed of preferably 40 meters/minute and a maximum current intensity of 5000 Amp. Subsequently the tube passes through a cooling chamber where the temperature of the metal is reduced to room temperature, to finally roll the tube inside a basket. Protective wax is applied during the passage to that zone.

The zone of the furnace and cooling chamber are constantly saturated with the same purged noble gas, preferably nitrogen.

The final product is a tube with an equiaxial grain structure having an average size of 0.040 mm. Also, as it is worked in an inert environment this avoids the forming of oxidation on the tube's surface, therefore the final product complies with the characteristics identified commercially.

Once the process is known, these are the principal advantages that the tube manufacturing process using continuous vertical casting has versus the traditional procedures:
1. It increases productivity because the size of the lot of the continuous vertical casting line is twenty times higher than the traditional procedure (1500 kg vs. 75 kg respectively), which optimizes the use of energy in approximately 18%, losses of material in approximately 40%.
2. It does not require prior melting for the manufacture of the cylinders as the line has its own small smelting works. This reduces the consumption of energy and the pollutant emissions of a traditional melting process as the metal is heated by induction.
3. It permits the obtaining of tubes of different sizes and especially of a smaller diameter in a shorter time in the termination process. This is a very important characteristic in relation to energy consumption and losses of material because less processing steps are required to arrive at the end product.
4. Being able to start off with pre-tubes having smaller diameters makes it possible to arrive at smaller diameter tubes with greater safety and quality as the melt has been exposed to less stress. In the best of cases, the percentage of reprocessing in the traditional system reaches 25%; with the vertical continuous casting process and the process that is the object of this patent it is possible to reach a 5% of reprocessing.
5. The final tube that passed through the vertical continuous casting process differs in the chemical composition shown in the following table I, in which a diminution in the amount of S and O₂ can be appreciated.

| | Maximum impurities | | | | | | | | | | | | |
|---|---|---|---|---|---|---|---|---|---|---|---|---|---|
| | P | S | As | Zn | Ni | Fe | Pb | Sb | Bi | Ag | Sn | O | Cu + Ag |
| Process | % | ppm | % | % | % | % | % | % | % | % | % | ppm | % |
| C12200 | 0.015- | 60 | 0.020 | 0.015 | 0.025 | 0.012 | 0.005 | 0.005 | 0.002 | — | 0.005 | 70 | 99.9 |
| | 0.030 | | | | | | | | | | | | min |
| Invention | 0.024 | 6.58 | 0.001 | 0.000 | 0.000 | 0.001 | 0.000 | 0.000 | 0.000 | 0.001 | 0.000 | 10.45 | 99.970 |
| Traditional | 0.020 | 13.39 | 0.001 | 0.001 | 0.001 | 0.001 | 0.001 | 0.000 | 0.000 | 0.001 | 0.000 | 51.73 | 99.972 |

6. The size of the homogeneous grain for 95% of the pre-tube annealed in the induction furnace has an equiaxial grain structure with an average size of 0.040 mm (FIG. 17).
7. The processing time of 1000 kg by way of continuous vertical casting for a 3/4L product is 45% faster than the traditional process.
8. The personnel required for the production of the continuous vertical casting is 35% lower than that used in the traditional process.
9. The type of grain with which one wants to materialize the tube can be selected.

Comparatively, the tube itself, obtained via the process described in this invention, is very different to the products in the processes of the prior state of the art.

These physical characteristics can be analyzed on the basis of the following table II:

TABLE II

| | Tube | Grain size | Hardness | |
|---|---|---|---|---|
| Process | (mm) | (mm) | HRF | Comments |
| Traditional | 85*8 | 0.09 | 81 | Equiaxial non |
| process | | | | homogenous |
| Piercing | | | | grains |
| Pre-tube | 38*2.5 | 0.461*0.206 | 53 | With columnar |
| vertical | | | | non homogenous |
| casting | | | | grains |
| Invention | 28.2*1.9 | 0.03 | 35 | Homogenous |
| | | | | equiaxial |
| | | | | grains |

From an analysis of Table II it is clear that grain distribution for the process of this invention is highly homogeneous, which reduces the speed of oxidation and deterioration of the tube. The rest of the tests are part of the state of the art where non homogenous grains and/or macrograins are obtained with large spaces where the oxygen penetrates and increases the variability in their distribution generating numerous spaces, thus making oxygen penetration easier.

The combination of grain size and hardness provide better mechanical properties for tube production to the end consumer.

Finally, the pre-tube is presented in the penultimate line, which corresponds to the development closest to this invention and the last line of the table corresponds to the innovative system with the application of this patent.

### DESCRIPTION OF FIGURES

FIG. 1.
(1) Dies
(2) Plugs

FIG. 2.
(1) Dies
(2) Plugs
(3) Pre-tube

FIG. 3.
(1) Dies
(3) Fixed mandrel
(4) Pre-tube

FIG. 4.
(5) Traditional process
(5a) Smelting
(5b) Piercing or rotary pressure system
(5c) Pickling
(5d) Taperer 1
(5e) Bench 120,000 lbs.
(5f) Taperer 2
(5g) Bench 50,000 lbs.
(5h) Bull Block 10,000 lbs.
(7) Cutting process

FIG. 5.
(6) Continuous vertical casting process
(6a) Continuous melting
(6b) Wiredrawing in tandem
(6c) Annealing
(6d) Spinner
(7) Cutting process

FIG. 6
(5) Traditional process
(5a) Smelting
(5b) Piercing or rotary pressure system
(5c) Pickling
(5d) Taperer 1
(5e) Bench 120,000 lbs.
(5f) Taperer 2
(5g) Bench 50,000 lbs.
(5h) Bull Block 10,000 lbs.
(6) Continuous vertical casting process
(6a) Continuous melting
(6b) Wiredrawing in tandem
(6c) Annealing
(6d) Spinner
(7) Cutting process

FIG. 7

FIG. 8
(8) Squeeze rollers
(9) Traction rollers
(10) Fishing tube
(11) Cooling water
(12) Furnace
(13)Kaowool sleeve
(14) Fishing point
(15) Graphite cup
(16) Liquid copper
(17) Graphite matrix

FIG. 9.
(14) Fishing point
(18) New pre-tube
(19) Solidification front

FIG. 10.
(14) Fishing point
(18) New pre-tube
(19) Solidification front

FIG. 11.
(18) New pre-tube
(19) Solidification front

FIG. 12.

FIG. 13.

FIG. 14.

FIG. 15.

FIG. 16.

FIG. 17.

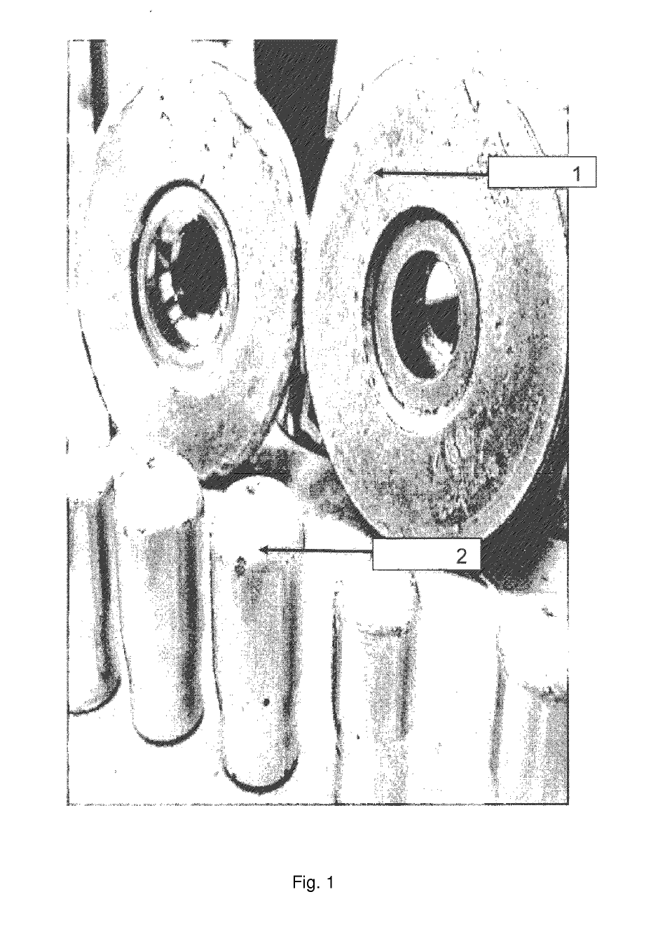

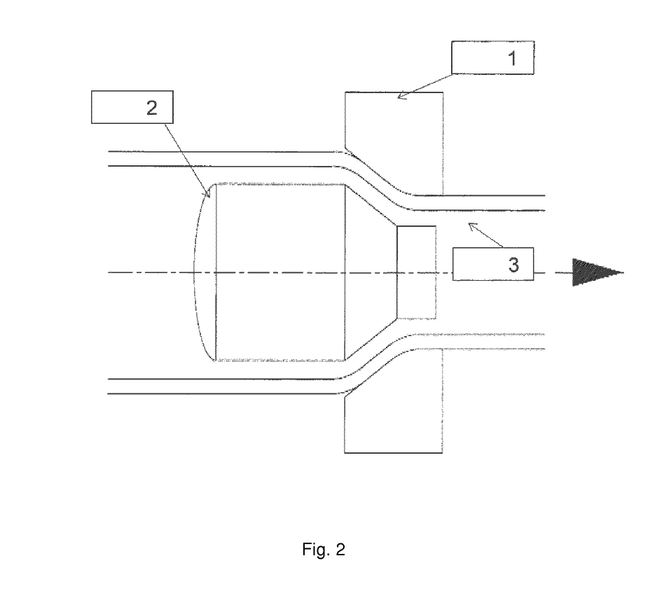

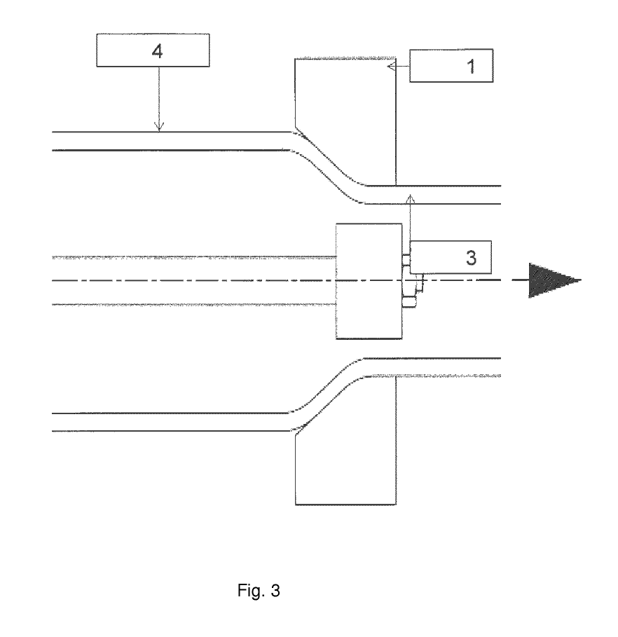

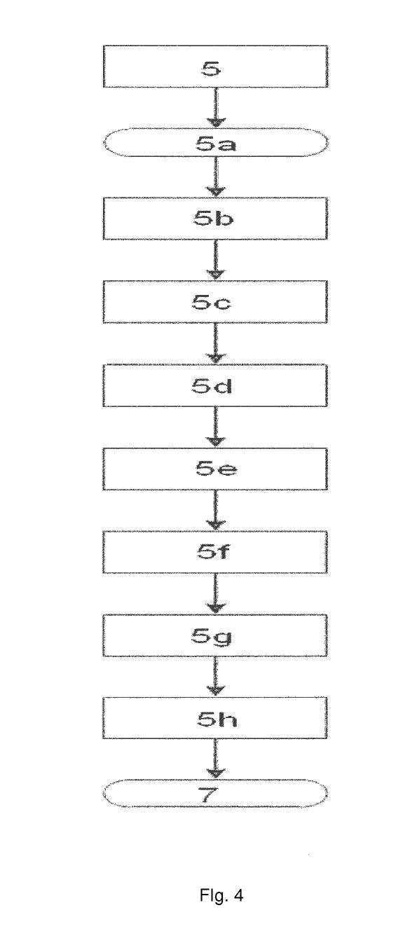

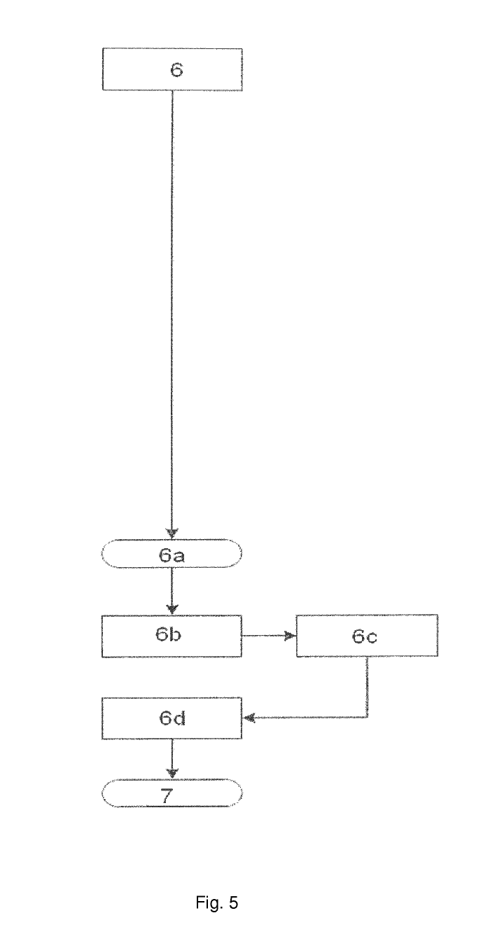

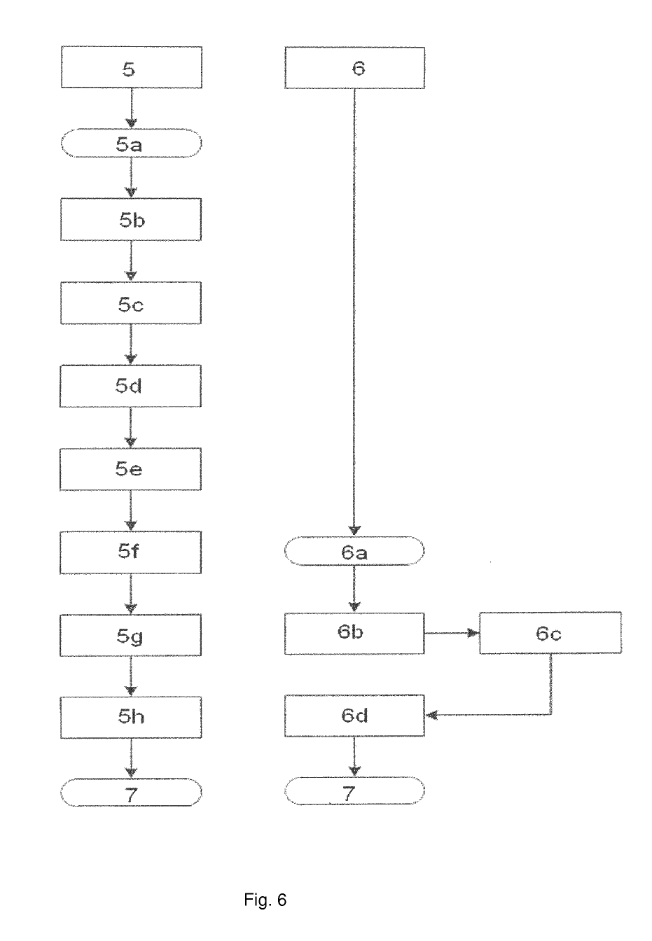

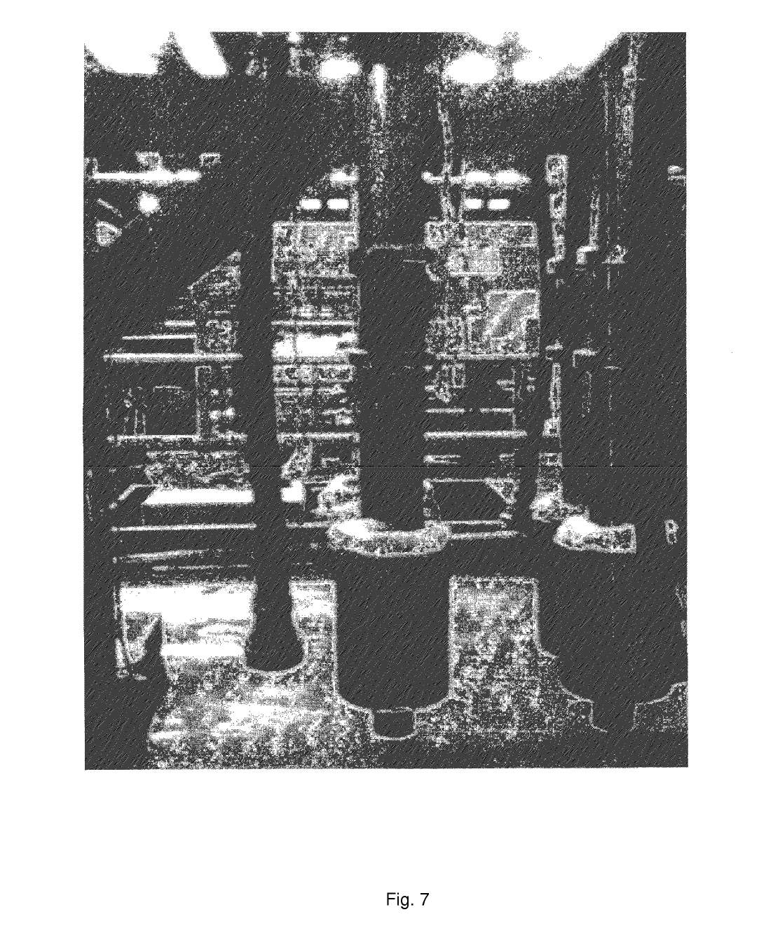

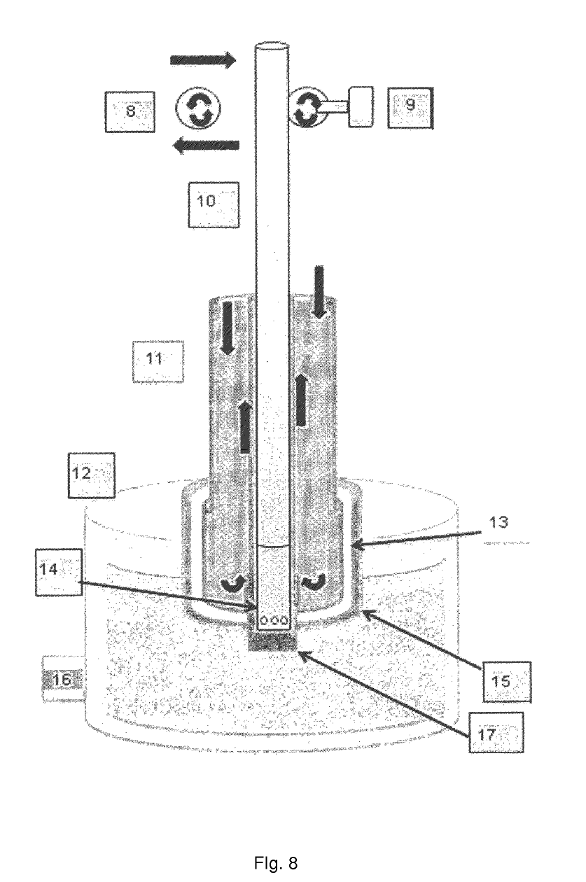

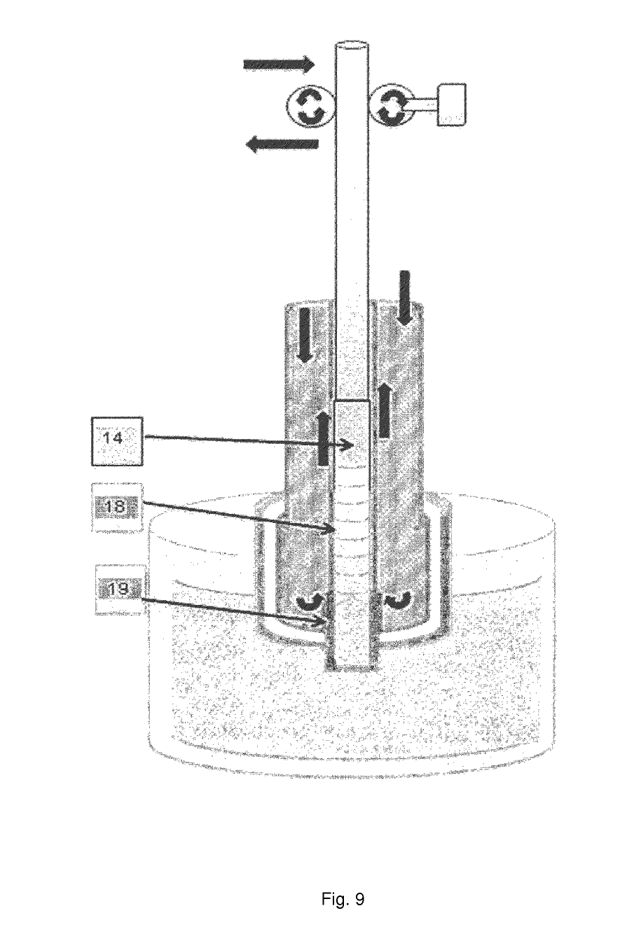

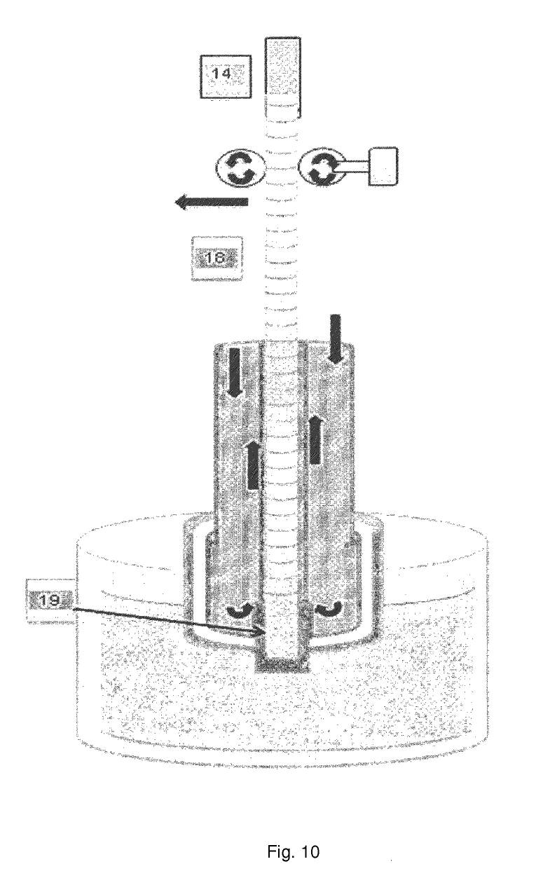

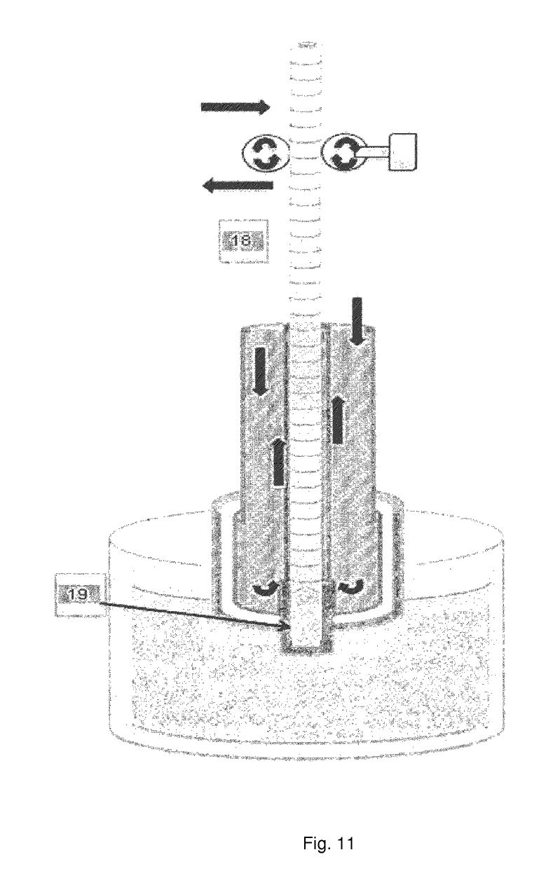

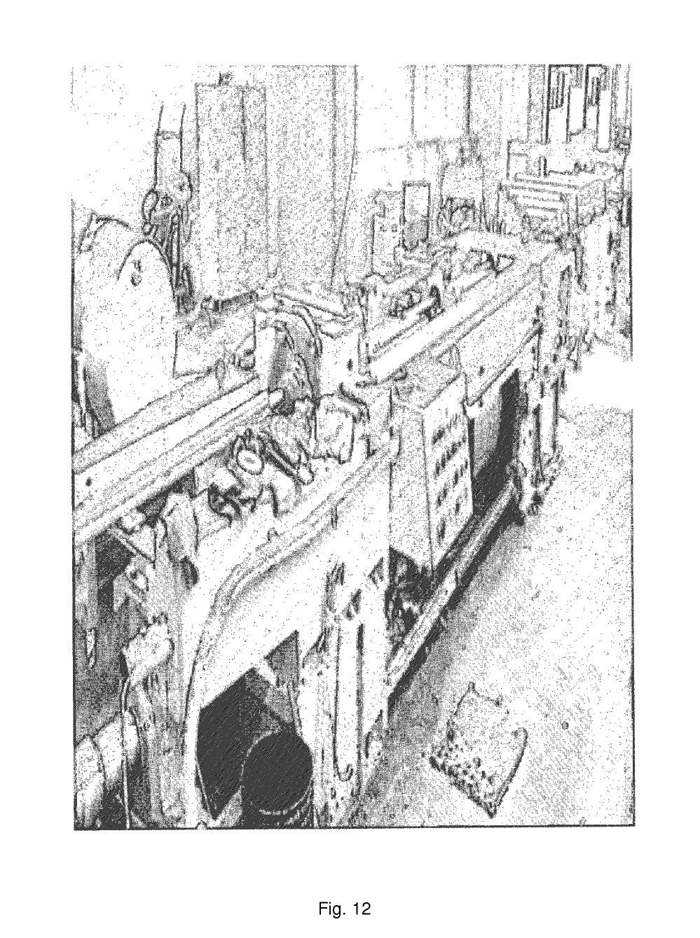

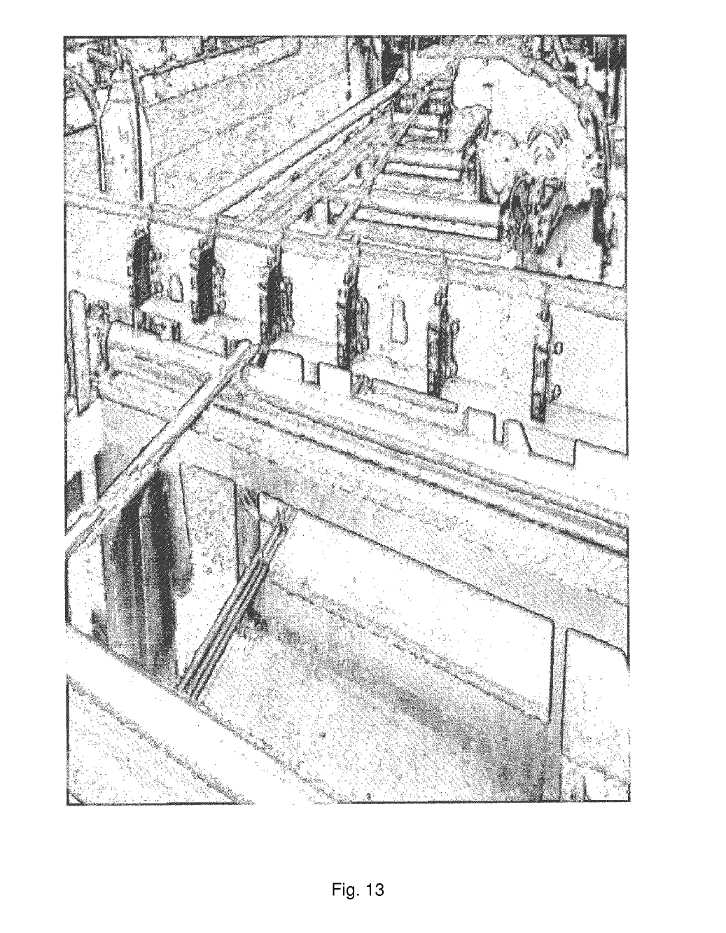

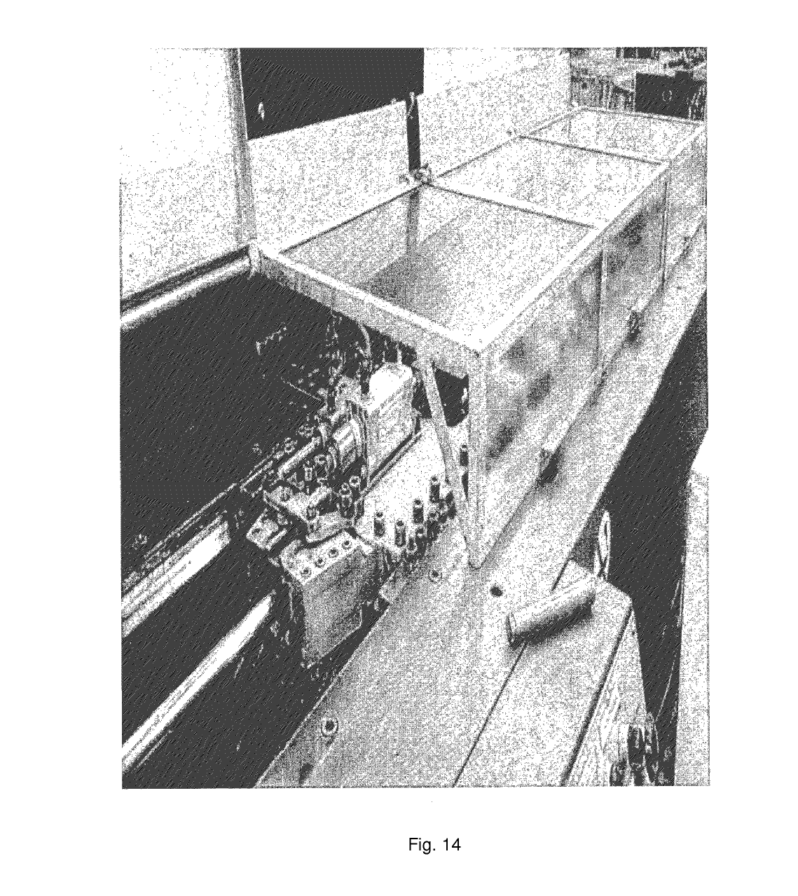

FIG. 18. Comparative micrographs of the products obtained in the different processes of the state of the art and the current process of the invention.
(20) Section of a copper pipe with large size, non uniform grains, with spaces for the oxidation, of the continuous vertical casting process with the annealing process known in the state of the art.
(21) Section of a copper pipe with macro grains, segregation, with ample space for the oxidation, of the classic processes known in the state of the art, without the continuous casting system.
(22) Section of a copper pipe with homogeneous formation of grains, with minimum segregation and minimum spaces for the oxidation, of the process of this invention subsequent to the formation of the new pre-tube by the continuous casting.

### EXAMPLE OF APPLICATION

As an example of application, we shall bear in mind the manufacture of a nominal % inch standard tube for the construction industry.

Once 1300-1500 kilograms of the new pre-tube have been melted and cast through the continuous vertical casting, these are taken to the wiredrawing process section for a first and second wiredrawing in two wiredrawing machines working synchronously until a tube with a diameter of preferably 30.00'1.44 mm is reached.

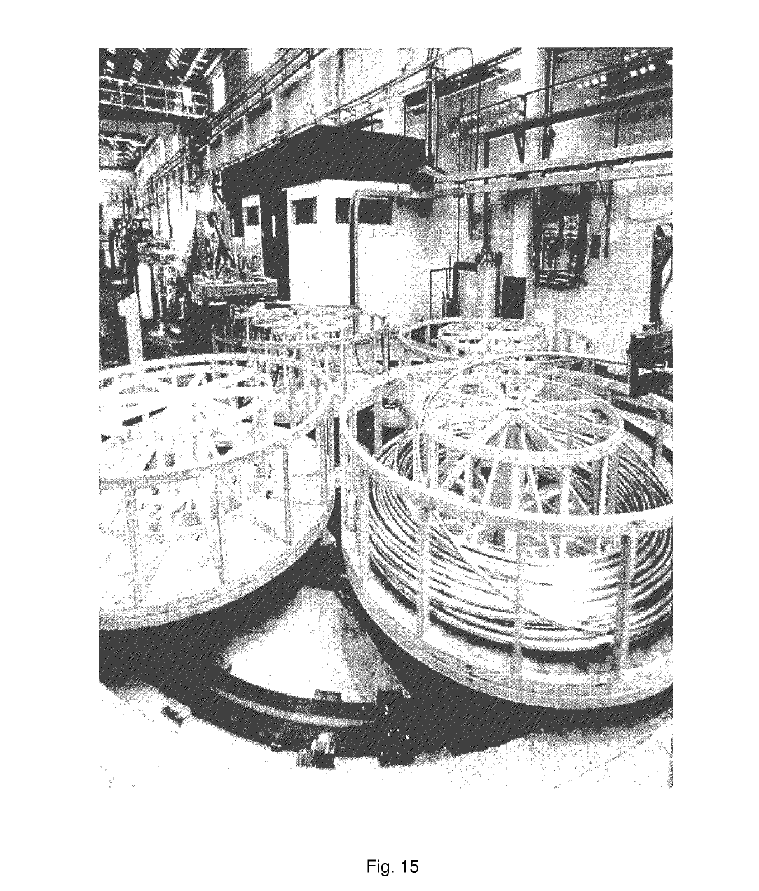

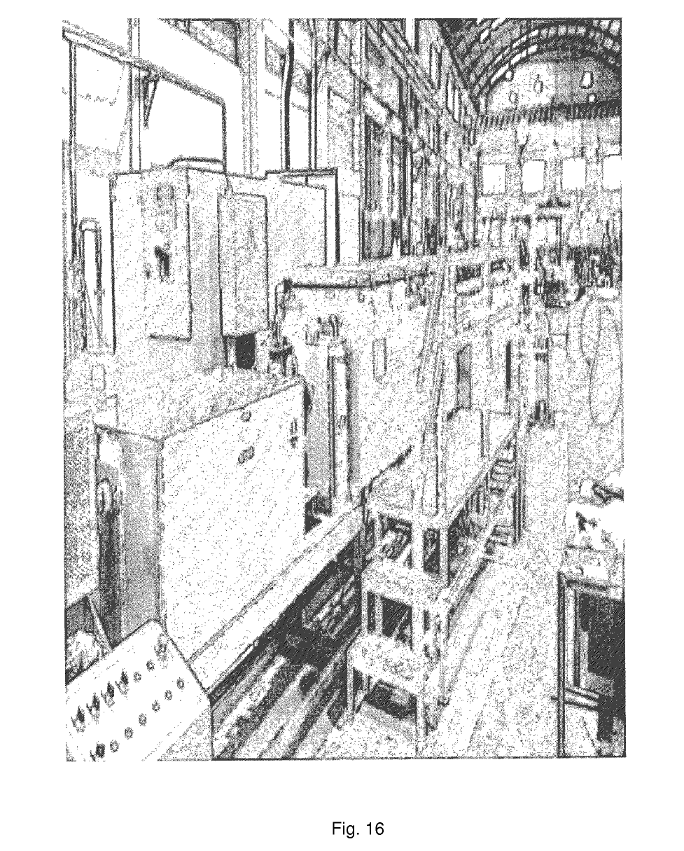

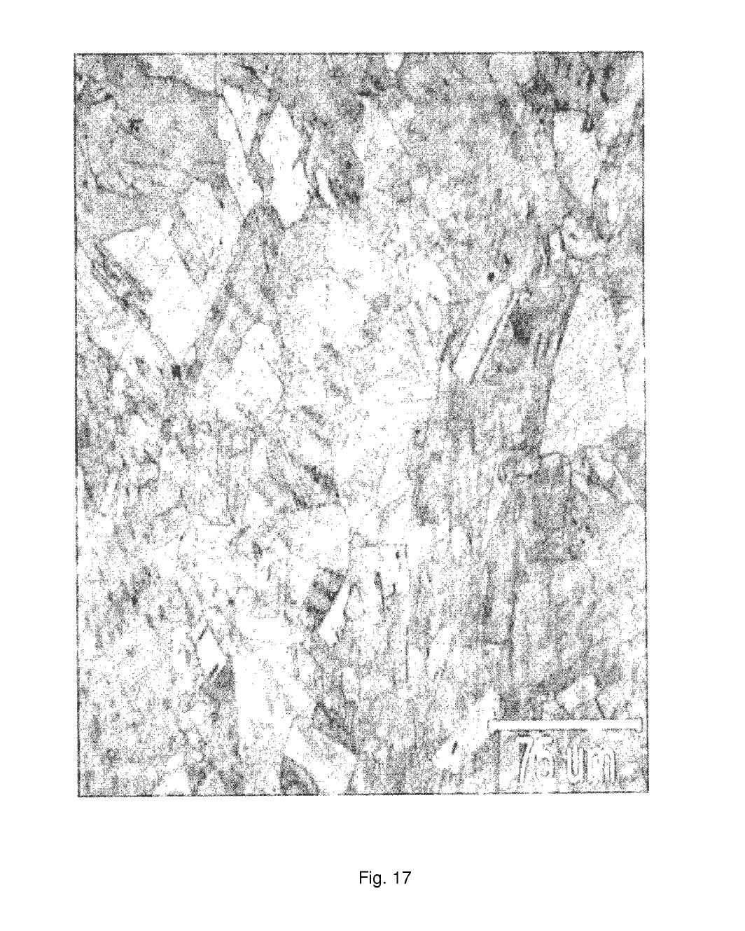

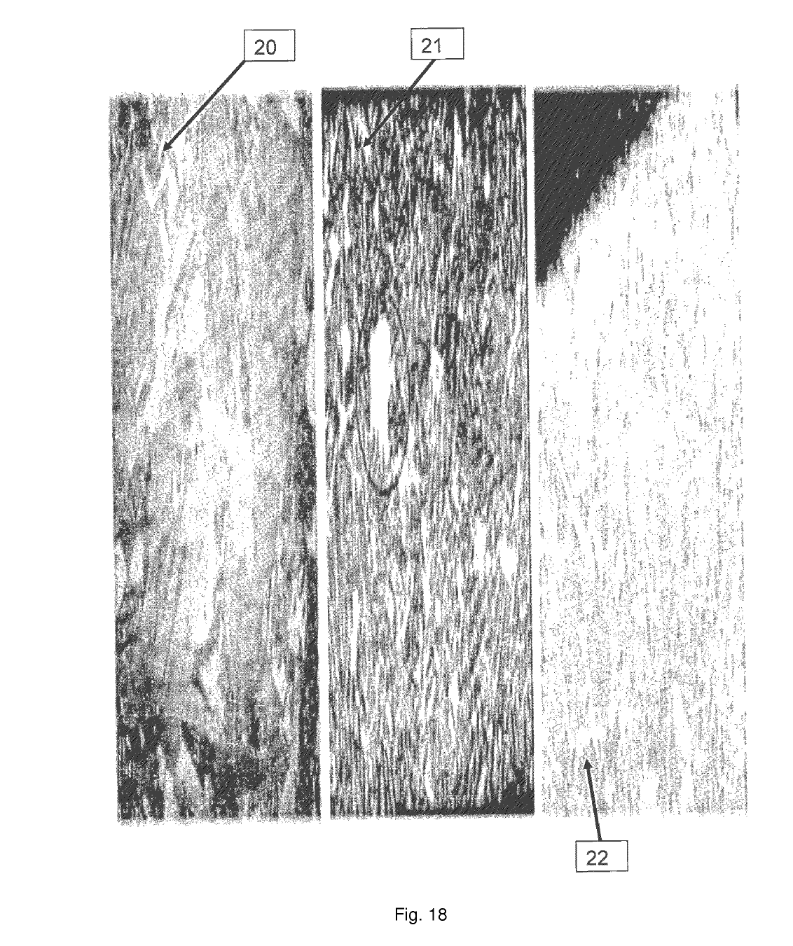

The product of these wiredrawing machines is accumulated in a basket as shown in FIG. 15 that links the wiredrawing process with the annealing process.

After being annealed, the material is processed in a circular wiredrawer giving a single wiredrawing undercut, and finally, the finishing undercut in the straight wiredrawers.

Comparatively, in the traditional process for the same nominal % inch tube for the construction industry, mentioned in the previous example, the flowchart of this process can be appreciated in FIG. 4. In that traditional process, the tube was extruded initially or was obtained by means of a mechanical process as was mentioned previously. Then, as the tube became hot and deformed, it needed to be manipulated to clean it of all impurities or traces of oxide. For the latter, a process known as “pickling” is executed that consists of a chemical bath to remove these impurities. Once the tube is clean, the point is made so that it can be stranded. Once this has been done, the tube is taken to the wiredrawing banks; these banks, where the tube is stretched, are approximately 30 to 40 meters long.

Once the initial reduction is carried out on the banks and a tube is produced that has a diameter close to the one desired, the tube passes to a wiredrawing process in rollers using circular wiredrawing machines. These have the same function as the banks but with smaller diameters and longer tubes. Once the desired diameter and thickness have been reached, the tube is cut in the lengths required commercially.

All this in accordance with the description in the comparison indicated in Table I attached previously.

1. A tube for the end consumer with minimum interior and exterior oxidation, CHARACTERIZED in that its grains can be selected in size and order.

2. A tube in accordance with claim 1, CHARACTERIZED in that the structural condition of the tube comprises a metal and/or a non metal, a metal alloy, metal compound, metal-ceramic alloy, ceramic or a polymer, preferably copper.

3. A tube in accordance with claim 2, CHARACTERIZED in that it has grains of a homogeneous formation, preferably equiaxial, with an average grain size in the range of 0.025 mm to 0.050 mm, preferably of 0.040 mm.

4. A tube in accordance with claim 2, CHARACTERIZED in that it has sulfur in a concentration range of 2 ppm-12 ppm, preferably 6.6 ppm and oxygen in a concentration range of 5 ppm-12 ppm, preferably 10.5 ppm.

5. A tube production process for the end consumer with minimum interior and exterior oxidation, whereby it is possible to obtain tubes with diameters smaller than that of the initial pre-tube, all executed by means of the process for forming pre-tubes in a continuous vertical casting that optimizes the consumption of energy, the man-hours, the productivity, the loss of material and the production of pollutants, CHARACTERIZED in that it comprises the following stages:
a) The pre-tube obtained from the continuous vertical casting process is prepared with the tapering equipment, the pre-tube is lubricated internally and a wiredrawing chuck is inserted. Then a point is made at the beginning of the roll of pre-tube and it is inserted in the spool.
b) The first wiredrawer is started up at a constant speed;
c) The tube that comes out of the first wiredrawer passes through tension regulating equipment in tandem;
d) The tube that has already passed through the first wiredrawer contained by the tension regulating equipment passes to the second wiredrawer also in tandem, where a second reduction is carried out;
e) The material that comes out of the second wiredrawer is accumulated continuously in baskets;
f) The material accumulated and that has passed through two wiredrawers enters the annealing furnace in order to realign the microstructure of the final tube reducing the oxidation speed so that it can be stranded;
g) The tube is purged internally with noble gas;
h) The exterior of the tube is cleaned;
i) The furnace heats the tube by induction;
j) The tube quickly passes into a cooling chamber;
k) The final tube is rolled up in a basket for its subsequent dimensioning.

6. A production process in accordance with claim 5, CHARACTERIZED in that stage j) produces DHP (“Deoxidized High Phosphorus”) tubes with measurements in the range of 22.22 mm in diameter by 1.14 mm thick up to 4.76 mm in diameter by 0.30 mm thick, preferably a diameter of 38 mm and a wall thickness of 2.5 mm.

7. A production process in accordance with claim 5, CHARACTERIZED in that the input speed to the process comprises a maximum speed of the continuous vertical casting of 1 m/min, water flow of 50 L/min and a water pressure of 8 bar.

8. A production process in accordance with claim 5, CHARACTERIZED in that the raw material of the wiredrawers that work synchronized and in tandem is the pre-tubes produced in the continuous vertical casting, and a reduction is applied in the first reduction in the range of 30.25% to 38.38% preferably of 38.38% and in the second reduction in the range of 22.69% to 26:78% preferably 26.78%, achieving an accumulated reduction in the range of 46.08% to 54.88%, preferably of 54.88%.

9. A production process in accordance with claim 5, CHARACTERIZED in that the wiredrawers at points c) and e) work at an average speed of 35 m/min and they also have a cooling system in each machine.

10. A production process in accordance with claim 9, CHARACTERIZED in that paraffin is used as an exterior lubricating/cooling agent.

11. A production process in accordance with claim 5, CHARACTERIZED in that the induction furnace works with the product of the wiredrawing machines at a speed preferably in the range of 6m/min-40 m/min, and with a power preferably in the range of 1200-5000 A.

12. A production process in accordance with claim 11, CHARACTERIZED in that the induction furnace works at a speed of 40 m/min preferably with a power of 600 Kva.

13. A production process in accordance with claim 11, CHARACTERIZED in that the solvent used in point h) is preferably turpentine prior to entering the furnace and with protective wax between the cooling zone and the coiling zone.

14. A production process in accordance with claim 5, CHARACTERIZED in that the noble gas used from point g) onwards is preferably nitrogen.
